(19) United States
(12) Patent Application Publication
(10) Pub. No.: US 2008/0039310 A1
(43) Pub. Date: Feb. 14, 2008

(54) QUARTZ-TYPE GLASS AND PROCESS FOR ITS PRODUCTION

(75) Inventors: Hideaki HAYASHI, Yokohama-shi (JP); Akio Koike, Yokohama-shi (JP); Mitsuhiro Kawata, Yokohama-shi (JP); Naoki Sugimoto, Yokohama-shi (JP); Shinya Kikugawa, Tokyo (JP); Kenji Yamada, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 11/865,289

(22) Filed: Oct. 1, 2007

Related U.S. Application Data
(63) Continuation of application No. PCT/JP2006/306379, filed on Mar. 22, 2006.

(30) Foreign Application Priority Data
Mar. 29, 2005 (JP) 2005-095829

(51) Int. Cl. C03B 19/00

(52) U.S. Cl. 501/55; 65/17.6; 65/30.1; 65/60.3; 501/64

(57) ABSTRACT

To provide quartz-type glass for a microlithographic projection exposure apparatus, which contains at least 51 mass % of SiO₂ and which further contains at least one member selected from the group consisting of lanthanum, aluminum, hafnium, nitrogen, scandium, yttrium and zirconium. It is a material which is useful for an illumination system for a microlithographic projection exposure apparatus or as a projection object lens and has a refractive index at 248 nm larger than 1.508 of quartz glass and a refractive index at 193 nm larger than 1.560 of quartz glass and which can be small-sized.

### TECHNICAL FIELD

The present invention relates to quartz-type glass for a microlithographic projection exposure apparatus.

### BACKGROUND ART

In an optical system for microlithography, synthetic quartz glass is usually employed. Along with high integration and high functionality of integrated circuits, miniaturization of integrated circuits has been advanced, and an exposure apparatus or stepper is required to form a circuit pattern on a wafer in a deep focal depth with a high resolution. Accordingly, shortening of the wavelength of the exposure light source is being advanced. The exposure light source has been advanced from conventional g-line (wavelength: 436 nm) i-line (wavelength: 365 nm) or KrF excimer laser (wavelength: 248 nm) to ArF excimer laser (wavelength: 193 nm) which is now being employed.

Further, in order to meet the requirements for integrated circuits of next generation where the line width of a circuit pattern will be 100 nm or less, immersion lithography technology employing KrF laser or ArF laser has been proposed. This is a technique wherein as shown in FIG. 1, an immersion liquid 2 having a refractive index higher than air (e.g. pure water having a refractive index of 1.432 at a wavelength of 193 nm) is filled between a projection lens 3 and a wafer 1, thereby to increase the numerical aperture of the lens through which the laser beam 4 will pass and to improve the resolution and focal depth.

As such a projection lens, presently, a calcium fluoride single crystal excellent in transmittance of 193 nm (having a refractive index of 1.501 at a wavelength of 193 nm) or quartz glass (having a refractive index of 1.560 at a wavelength of 193 nm) is used (Patent Document 1). Recently, in order to further improve the resolution, it is desired to increase the numerical aperture of the lens further to at least 1.0.

Patent Document 1: JP-A-2005-003982

### DISCLOSURE OF THE INVENTION

### Problems which the Invention is to Solve

There was a problem that when it was attempted to increase the numerical aperture of a lens, the lens was obliged to be large. It was practically difficult to produce quartz glass or a calcium fluoride single crystal for a lens having a diameter exceeding 300 mm, and even if it was possible to produce it, there was a problem that the cost also increased.

Further, in a case where it was attempted to increase the numerical aperture without increasing the size of the lens, it was necessary to increase the curvature of the lens, and processing for such a purpose was difficult, and even if possible, such processing was costly. If it is possible to adjust the refractive index at a wavelength of 193 nm to be larger than 1.560 of conventional quartz glass, or if it is possible to adjust the refractive index at a wavelength of 248 nm to be larger than 1.508 of conventional quartz glass, it becomes possible to make the size small while the curvature of the lens is maintained. It is an object of the present invention to provide quartz-type glass which is capable of solving the above mentioned problems.

### Means to Solve the Problems

The present invention provides the following:

1. Quartz-type glass for a microlithographic projection exposure apparatus, which contains at least 51 mass % of SiO₂ and which further contains at least one member selected from the group consisting of lanthanum, aluminum, hafnium, nitrogen, scandium, yttrium and zirconium.

2. Quartz-type glass for a microlithographic projection exposure apparatus, which contains at least 51 mass % of SiO₂ and which further contains lanthanum and at least one member selected from the group consisting of hafnium and nitrogen.

3. Quartz-type glass for a microlithographic projection exposure apparatus, which contains at least 51 mass % of SiO₂ and which further contains at least two members selected from the group consisting of aluminum, hafnium and nitrogen.

4. Quartz-type glass for a microlithographic projection exposure apparatus, which contains at least 51 mass % of SiO₂ and which further contains hafnium and nitrogen.

5. The quartz-type glass for a microlithographic projection exposure apparatus according to the above item 1, which is quartz-type glass containing lanthanum and aluminum, wherein lanthanum is contained in an amount of from 0.1 to 25 mass % as calculated as La, and aluminum is contained in an amount of from 0.1 to 15 mass % as calculated as Al.

6. The quartz-type glass for a microlithographic projection exposure apparatus according to any one of the above items 1 to 4, which is quartz-type glass containing hafnium, wherein hafnium is contained in an amount of from 1 to 25 mass % as calculated as Hf.

7. The quartz-type glass for a microlithographic projection exposure apparatus according to any one of the above items 1 to 4, wherein nitrogen is contained in an amount of from 0.1 to 10 mass %.

8. The quartz-type glass for a microlithographic projection exposure apparatus according to any one of the above items 1 to 7, which is used for microlithography with a light source having a wavelength of 193 nm.

9. The quartz-type glass for a microlithographic projection exposure apparatus according to any one of the above items 1 to 8, which has a refractive index of more than 1.560 at a wavelength of 193 nm.

10. The quartz-type glass for a microlithographic projection exposure apparatus according to any one of the above items 1 to 9, which is used for microlithography by an immersion exposure method.

11. The quartz-type glass for a microlithographic projection exposure apparatus according to any one of the above items 1 to 7 and 10, which has a refractive index of more than 1.508 at a wavelength of 248 nm.

12. A process for producing quartz-type glass for a microlithographic projection exposure apparatus, which comprises impregnating a porous quartz-type glass body with a solution of at least one member selected from the group consisting of alkoxides of lanthanum, aluminum, hafnium, scandium, yttrium and zirconium by a solution impregnation method, followed by removal of a solvent and transparent vitrification.

13. A process for producing quartz-type glass for a microlithographic projection exposure apparatus, which comprises a step of subjecting a vapor of SiCl₄ to hydrolysis in a flame to form a porous quartz-type glass body, wherein a solution containing a metal chloride, a metal nitrate or a metal alkoxide of at least one metal element selected from the group consisting of lanthanum, aluminum, hafnium, scandium, yttrium and zirconium, in at least one of water and an organic solvent, is formed into droplets and sprayed into the flame to form a porous quartz-type glass body containing the above metal element, followed by transparent vitrification of the porous quartz-type glass body.

### EFFECTS OF THE INVENTION

According to the present invention, it is possible to obtain quartz-type glass having a high refractive index exceeding 1.508 at a wavelength of 248 nm or exceeding 1.560 at a wavelength of 193 nm. Accordingly, it is suitable for a projection objective lens for an illumination system to be used in immersion lithography technology employing KrF laser or ArF laser.

### BRIEF DESCRIPTION OF THE DRAWINGS

FIG. 1 is a schematic view illustrating immersion lithography technology.

FIG. 2 is a schematic view illustrating an embodiment wherein quartz-type glass of the present invention is prepared by a liquid spray method.

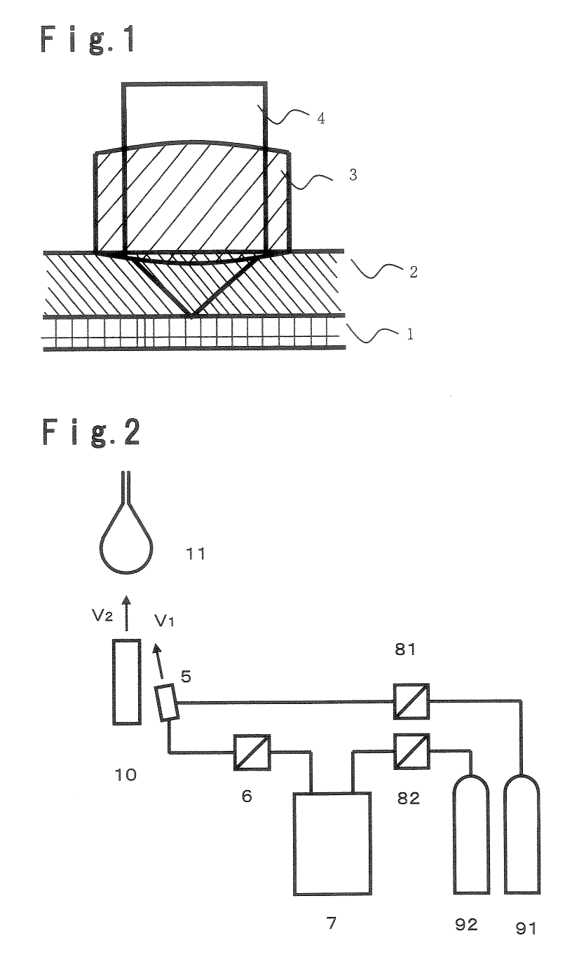

In these Figs., reference numeral 1 represents a wafer, 2 an immersion liquid, 3 a projection lens, 4 a laser beam, 5 a nozzle, 6 a solution amount control equipment and valve, 7 a raw material tank, 81 or 82 a pressure controller and valve, 91 or 92 a compressed gas cylinder, 10 an oxyhydrogen flame burner, and 11 a seed rod.

### BEST MODE FOR CARRYING OUT THE INVENTION

In the quartz-type glass of the present invention, SiO₂ is essential. SiO₂ is preferably contained in an amount of at least 51 mass %, more preferably at least 57 mass %. If it is less than 51 mass %, the transmittance at a wavelength of 193 nm tends to be inadequate. Further, the quartz-type glass of the present invention contains at least one member selected from the group consisting of lanthanum, aluminum, hafnium, nitrogen, scandium, yttrium and zirconium.

Lanthanum is preferably contained in an amount of from 0.1 to 25 mass %, as calculated as La. In this specification, “lanthanum is contained in an amount of from 0.1 to 25 mass % as calculated as La” means that the value of (mass of La₂ in the glass/mass of La₂O₃ in the glass)×100 is from 0.1 to 25. If it is less than 0.1 mass %, the refractive index may not be sufficiently increased as compared with conventional quartz glass. On the other hand, if it exceeds 25 mass %, vitrification tends to be difficult, or the glass may not transmit a light with a wavelength of 193 nm. It is more preferably from 0.5 to 20.5 mass %.

When lanthanum is contained, aluminum is preferably contained at the same time with a view to suppressing phase separation of the glass. In such a case, aluminum is preferably contained in an amount from 0.1 to 15 mass % as calculated as Al, more preferably at most 10.5 mass %. In this specification, “aluminum is contained in an amount of at most 15 mass % as calculated as Al” means that the value of (mass of Al₂ in the glass/mass of Al₂O₃ in the glass)×100 is at most 15. If it exceeds 15 mass %, the glass may not transmit a light with wavelength of 193 nm.

When aluminum is contained alone, it is preferred that aluminum is contained in an amount of at least 1 mass % and at most 15 mass % as calculated as Al. If it is less than 1 mass %, the refractive index may not be sufficiently increased as compared with the conventional quartz glass. If it exceeds 15 mass %, the glass may not transmit a light with a wavelength 193 nm.

When hafnium is contained, it is preferred that it is contained in an amount of from 1 to 25 mass % as calculated as Hf. In this specification, “hafnium is contained in an amount of from 1 to 25 mass % as calculated as Hf” means that the value of (mass of Hf in the glass/mass of HfO₂ in the glass)×100 is from 1 to 25. If it is less than 1 mass %, the refractive index may not be sufficiently increased as compared with the conventional quartz glass. It is more preferably at least 2.5 mass %. On the other hand, if it exceeds 25 mass %, vitrification tends to be difficult, or the glass may not transmit a light with a wavelength of 193 nm.

When nitrogen is contained, it is preferred that nitrogen is contained in an amount of from 0.1 to 10 mass %. If it is less than 0.1 mass %, the refractive index may not be sufficiently increased as compared with conventional quartz glass. Further, if it exceeds 10 mass %, vitrification tends to be difficult, or the glass may not transmit a light with a wavelength of 193 nm.

Scandium and zirconium may be incorporated in the glass as elements to improve the refractive index. In such a case, each of them is contained preferably in an amount of at most 10%. Yttrium may be incorporated in the glass as an element to improve the refractive index. In such a case, it is contained preferably in an amount of at most 15%.

The quartz-type glass of the present invention may be produced by a liquid spray method, a gas phase synthesis, a solution impregnation method, a melting method or a sol-gel method. As a gas phase synthesis, a VAD method may, for example, be mentioned wherein a vapor of e.g. SiCl₄ is subjected to flame hydrolysis in an oxyhydrogen flame to obtain fine particles of quartz glass. A process for preparing quartz-type glass containing any one of metal elements selected from lanthanum, scandium, yttrium, aluminum, hafnium and zirconium, is as follows.

Firstly, a metal chloride solid material, a metal chloride liquid material or a metal alkoxide of such a metal is vaporized under heating and subjected to hydrolysis in an oxyhydrogen flame together with e.g. SiCl₄ to prepare a porous quartz-type glass body containing the metal element. As a target to deposit fine particles of glass thereon to prepare a porous quartz-type glass body, a seed rod made of quartz glass which rotates about its axis as the center at a constant speed (such as a seed rod disclosed JP-B-63-24973). Such a target is not limited to a rod, and a target in a plate shape may be employed. Then, this glass body is heated to the transparent vitrification temperature and vitrified to be transparent to obtain quartz-type glass (hereinafter referred to as transparent vitrification). In this specification, transparent vitrification means a state wherein the glass body is densified to such a level that no void can be detected by an optical microscope, and the transparent vitrification temperature is a temperature at which the glass body can be densified to such a level that no void can be detected by an optical microscope.

The transparent vitrification temperature is usually from 1,400 to 1,850° C., particularly preferably from 1,450 to 1,800° C. The atmosphere is preferably an atmosphere of 100% inert gas such as helium or argon or an atmosphere containing an inert gas such as helium or argon as the main component. The pressure may be a reduced pressure or normal pressure. Particularly in the case of normal pressure, helium gas or argon gas may be employed. Further, in the case of a reduced pressure, it may preferably be at most 13,000 Pa. In this specification, “Pa” means an absolute pressure i.e. not a gauge pressure.

A solution having a metal chloride material, a metal nitrate material or a metal alkoxide material (solid or gas) dissolved in water, methanol, ethanol, isopropanol, toluene, n-hexane, benzene, xylene or the like, is formed into droplets and then sprayed into an oxyhydrogen flame wherein flame hydrolysis of a vapor of SiCl₄ or the like is being carried out, whereby a porous quartz-type glass body containing the metal element can be prepared. This glass body is subjected to transparent vitrification to obtain quartz-type glass (hereinafter referred to as a liquid spray method).

FIG. 2 is a schematic view illustrating an embodiment wherein quartz-type glass of the present invention is prepared by the liquid spray method. The solution filled in a raw material tank 7 is pressurized by a gas supplied from a compressed gas cylinder 92 connected via a pressure controller and valve 82 and supplied to a nozzle 5 connected via a solution amount controlling equipment and valve 6. To the nozzle 5, another gas (hereinafter referred to as a spray gas) is supplied by a compressed gas cylinder 91 connected via a pressure controller and valve 81, to carry out formation of droplets of the solution.

The droplets are sprayed into the flame of an oxyhydrogen flame burner 10 wherein SiCl₄ or the like being a material for the synthesis of synthetic quartz glass is supplied and hydrolyzed, whereby a porous quartz-type glass body containing the above metal elements will be deposited on the seed rod 11.

The raw material for the synthesis of synthetic quartz glass is not particularly limited so long as it is a raw material which can be gasified. For example, a silicon halide compound such as a chloride such as SiCl₄, SiHCl₃, SiH₂Cl₂ or SiCH₃Cl₃ or a fluoride such as SiF₄, SiHF₃ or SiH₂F₂, an alkoxysilane represented by RₙSi(OR)₄₋ₙ (wherein R is a C₁₋₄ alkyl group, and n is an integer of from 1 to 3), or a silicon compound containing no halogen such as (CH₃)₃Si—O—Si(CH₃)₃, may be mentioned.

With respect to the nozzle 5, in FIG. 2, a two fluids nozzle is illustrated, but a one fluid nozzle, a two fluids nozzle or an ultrasonic nozzle may, for example, be used. In a case where a one fluid nozzle or a two fluids nozzle is used, nitrogen, hydrogen, oxygen or the like may be used as a pumping gas to transport the above solution. As the solution amount control equipment and valve 6, a liquid mass flow controller or a needle valve may, for example, be employed. The gas to be filled in the compressed gas cylinder 91 or 92, nitrogen, hydrogen or oxygen may, for example, be used. The maximum linear velocity V₁ (m/s) of the spray gas at the surface of the seed rod on which fine particles of glass are to be deposited, is preferably V₁<2V₂, more preferably V₁<V₂, where V₂ is the maximum linear velocity of oxygen gas or hydrogen gas forming the oxyhydrogen flame at the surface of the above seed rod. If V₁≧2V₂, flickering of the oxyhydrogen flame tends to be large, and the temperature of the flame tends to decrease, or the flame length tends to be short, whereby it is likely that a porous quartz-type glass body can not be obtained. The nozzle 5 and the oxyhydrogen flame burner 10 are disposed in FIG. 2 so that extensions of the respective center axes will intersect with each other, but the disposition is not limited thereto. For example, they may be disposed so that such extensions will be parallel with each other, or they may be disposed so that the center axes of the nozzle 5 and the oxyhydrogen flame burner 10 will overlap with each other.

As the oxyhydrogen flame burner 10, concentric multiple nozzles (such as a burner disclosed in JP-B-62-50418) may, for example, be employed. The inner diameter d₁ (cm) of the outermost layer of the multiple nozzle burner is preferably d₂/d₁>2, more preferably d₂/d₁>4, where d₂ is the maximum diameter (cm) of the seed rod. If d₂/d₁≦2, in the process for preparing a porous quartz-type glass body, the glass body deposited on the seed rod is likely to break and fall.

The solution to be used for the liquid spray method contains preferably no solid particles of at least 200 μm, more preferably no solid particles of at least 50 μm. If solid particles of at least 200 μm are contained, the solid particles are likely to stick in the nozzle 5 or in the liquid amount control equipment and valve 6, whereby a constant supply of the solution tends to be impaired. The solvent to dissolve the metal chloride material and/or the metal nitrate material preferably contains a flammable liquid such as methanol, ethanol, isopropanol, toluene, n-hexane, benzene or xylene, and it is preferably a mixed solvent with water. The proportion of the flammable liquid in the solvent is preferably at least 10 masse. If the proportion of the flammable liquid in the solvent is less than 10 mass %, the temperature of the oxyhydrogen flame tends to be remarkably low, and a porous quartz-type glass body may not be deposited on the seed rod. In a case where water is not contained as a solvent, it is likely that a part of the metal chloride material and/or the metal nitrate material will not be dissolved, and solid particles of at least 200 μm may remain. The solvent to dissolve the metal alkoxide material preferably contains no water. If water is contained in the solvent, the metal alkoxide material is likely to undergo hydrolysis, whereby solid particles of at least 200 μm are likely to be formed.

Quartz-type glass containing one of the above mentioned metal elements may also be obtained by impregnating a porous quartz glass body obtained by the above VAD method with a solution of a metal compound such as a metal chloride or a metal alkoxide by a solution impregnation method, and drying it to remove the solvent, followed by transparent vitrification.

As the metal compound material, it is preferred to use a metal alkoxide from such a viewpoint that the amount of the metal element remaining in the glass obtained (the concentration after the transparent vitrification/the concentration in the solution) will be large, and segregation of the metal element tends to hardly take place. The metal alkoxide may optionally be selected depending upon the speed of hydrolysis or efficient availability. For example, in the case of lanthanum, lanthanum isopropoxide (La(—O-i-C₃H₇)₃) or lanthanum methoxypropylate (La(—O—CHCH₃CH₂OCH₃)₃ may, for example, be used.

As the solvent for preparing the solution of a metal compound such as a metal chloride or a metal alkoxide, water, methanol, ethanol, isopropanol, toluene, n-hexane, benzene or xylene may, for example, be used. In the case of a metal alkoxide, it is preferred to use toluene or xylene having a small polarity or n-hexane or benzene having no polarity. The impregnation with a metal alkoxide is preferably carried out in an inert atmosphere such as nitrogen in order to prevent it from a reaction with moisture in the air, and the dew point of the atmosphere is preferably less than 0° C.

The impregnation time may optionally be selected depending upon the concentration of the solute, but it is preferably at least 4 hours. If it is less than 4 hours, there may be a case where the solution may not penetrate into the interior of the porous quartz glass body, and the obtainable glass tends to be inhomogeneous.

The impregnation may be carried out under normal pressure or reduced pressure. If the impregnation is carried out under reduced pressure, the time for letting the solution penetrate into the interior of the glass body can be shortened. In the case of reduced pressure, it is preferably at most 13,000 Pa. The temperature for the removal of the solvent may optionally be selected depending upon the type of the solvent, but it is preferably at least 100° C.

Further, the removal of the solvent may be carried out under normal pressure or reduced pressure. In the case of reduced pressure, it is preferably at most 13,000 Pa. After completion of the impregnation with the solution, the glass body may immediately be dried to remove the solvent, but it is preferred that the porous glass body taken out from the solvent is left to stand in an atmosphere having a dew point of at least 0° C., and then, removal of the solvent is carried out. By using such a method, the hydrolytic reaction of the metal alkoxide with Si—OH in the interior of the glass body will be accelerated, whereby it is possible to increase the amount of metal element remaining in the glass obtained or to prevent segregation of the metal element. The time for being left to stand is preferably at least 24 hours. In order to accelerate the hydrolysis, ammonia vapor, hydrochloric acid vapor or the like may be introduced into the atmosphere.

Quartz-type glass containing nitrogen may be obtained by dissolving inorganic perhydrosilazane or the like in a solvent such as xylene, impregnating the glass body therewith, and drying it to remove the solvent, followed by transparent vitrification. The temperature for removing the solvent may be optionally selected depending upon the type of the solvent, but it is preferably at least 145° C. when xylene is used. In order to prevent the inorganic perhydrosilazane from a reaction with moisture in the air, it is preferred to carry out the impregnation in an inert atmosphere such as nitrogen, and the dew point of the atmosphere is preferably adjusted to be less than 0° C.

Further, quartz-type glass containing nitrogen may also be obtained by heating the porous quartz glass body in an ammonia atmosphere, followed by transparent vitrification. The ammonia concentration in the atmosphere is preferably at least 20 vol % The heating temperature at that time is preferably from 800 to 1,200° C. If it exceeds 1,200° C., ammonia is likely to be decomposed. Further, the heating time is preferably at least two hours.

The melting method is a method wherein a powder solid material batch is heated to obtain a melt, which is quenched to obtain glass.

Even by a well-known melting method, it is possible to prepare quartz-type glass containing any one of lanthanum, scandium, yttrium, aluminum, hafnium and scandium. As the raw materials, SiO₂ and a powder solid material of an oxide of the above metal element may be used. To facilitate vitrification by lowering the viscosity at a high temperature, an alkali metal carbonate such as Li₂CO₃, Na₂CO₃ or K₂CO₃, or an alkaline earth metal carbonate such as MgCO₃ or BaCO₃, may also be used. These materials may be prepared and mixed, melted in an alumina crucible, a platinum crucible or an iridium crucible and then cast on a mold, followed by annealing to remove any strain to obtain quartz-type glass.

The melting temperature is preferably at least 1,500° C. If it is less than 1,500° C., vitrification tends to be difficult. The melting time is preferably at least 4 hours. If it is less than 4 hours, gas-bubbles may remain in the glass. The melting may be carried out in an atmospheric air, but in a case where it is desired to reduce the moisture remaining in the glass, it is preferred to bring the dew point to a level of lower than 0° C. by introducing a mixed air gas into the atmosphere.

### EXAMPLES

Now, the present invention will be described in further detail with reference to Examples. However, it should be understood that the present invention by no means thereby restricted.

### Example 1

A vapor of SiCl₄ was subjected to flame hydrolysis in an oxyhydrogen flame to prepare a porous quartz glass body having a bulk density of 0.3 g/cm³. LaCl₃.7H₂O and AlCl₃ (each manufactured by Kanto Chemical Co., Inc.) were dissolved in ethanol to be 2.59×10⁻² g/cm³ and 1.12×10⁻² g/cm³, respectively, to obtain a solution, in which the above porous glass body was immersed for 24 hours. Then, the impregnated glass body was maintained in a nitrogen gas at 105° C. for 8 hours to completely evaporate ethanol as the solvent. The dried glass body was heated to 1,450° C. in an atmosphere of 100% helium gas and maintained at this temperature for 4 hours. Then, this glass body was heated to 1,800° C. in an atmosphere of 100% argon gas and maintained at this temperature for 4 hours to obtain transparent quartz-type glass. It contained lanthanum and aluminum in amounts of 0.5 mass % and 0.2 mass %, as calculated as La and Al, respectively.

### Example 2

A vapor of SiCl₄ was subjected to flame hydrolysis in an oxyhydrogen flame to prepare a porous quartz glass body having a bulk density of 0.3 g/cm³. Hafnium isopropoxide (Hf(—O-i-C₃H₇)₄, manufactured by Kojundo Chemical Laboratory Co., Ltd.) was dissolved to be 2.90×10⁻² g/cm³ to obtain a solution, in which the above porous glass body was immersed for 48 hours. Then, the impregnated glass body was maintained in nitrogen gas at 105° C. for 8 hours to completely evaporate ethanol as the solvent. This dried glass body was heated to 1,450° C. in an atmosphere of 100% helium gas and maintained at this temperature for 4 hours. Then, this glass body was heated to 1,800° C. in an atmosphere of 100% argon gas and maintained at this temperature for 4 hours to obtain transparent quartz-type glass. It contained hafnium in an amount of 2.5 mass % as calculated as Hf.

### Example 3

A vapor of SiCl₄ was subjected to flame hydrolysis in an oxyhydrogen flame to prepare a porous quartz glass body having a bulk density of 0.3 g/cm³. The porous glass body was immersed for 24 hours in a xylene solution containing 13 mass % of perhydropolysilazane (trade name V110, manufactured by AZ Electronic Materials (Japan) K.K.). Then, it was maintained in an atmosphere of nitrogen gas at 150° C. for 8 hours to completely evaporate xylene as the solvent. This dried glass body was heated to 1,450° C. in an atmosphere of 100% helium gas and maintained at this temperature for 4 hours. Then, this glass body was heated to 1,800° C. in an atmosphere of 100% argon gas and maintained at this temperature for 4 hours to obtain transparent quartz-type glass. It contained nitrogen in an amount of 2.0 mass % as calculated as N.

### Example 4

A vapor of SiCl₄ was subjected to flame hydrolysis in an oxyhydrogen flame to prepare a porous quartz glass body having a bulk density of 0.3 g/cm³. This glass body was heated to 1,450° C. in an atmosphere of 100% helium gas and maintained at this temperature for 4 hours for transparent vitrification to obtain quartz glass.

### Example 5

A vapor of SiCl₄ was subjected to flame hydrolysis in an oxyhydrogen flame to prepare a porous quartz glass body having bulk density of 0.3 g/cm³. Lanthanum methoxypropylate (La(—O—CHCH₃CH₂OCH₃)₃, manufactured by Hokko Chemical Industry Co., Ltd.) and aluminum isopropoxide (Al(—O-i-C₃H₇)₃, manufactured by Kojundo Chemical Laboratory Co., Ltd.) were dissolved in toluene to be 2.66×10⁻² g/cm³ and 5.81×10⁻² g/cm³, respectively, to obtain a solution, in which the above porous glass body was immersed under a reduced pressure of −30 kPa for 48 hours. The porous glass body taken out from the solution was left to stand still in atmospheric air for 240 hours. Then, it was maintained in nitrogen gas at 105° C. for 8 hours to completely evaporate toluene as the solvent. This dried glass body was heated to 1,450° C. in an atmosphere of 100% helium gas and maintained at this temperature for 4 hours. Then, this glass body was heated to 1,700° C. in an atmosphere of 100% argon gas and maintained at this temperature for 4 hours to obtain transparent quartz-type glass. It contained lanthanum and aluminum in amounts of 1.3 mass % and 0.4 mass %, as calculated as La and Al, respectively.

### Example 6

In accordance with the embodiment as shown in FIG. 2, quartz-type glass of the present invention was prepared by a liquid spray method. LaCl₃.7H₂O and AlCl₃.6H₂O (each manufactured by Kanto Chemical Co., Inc.) were dissolved in a mixed solvent of water/ethanol=1/1 to be 8.44×10⁻² g/cm³ and 5.49×10⁻² g/cm³, respectively, to prepare a solution, which was filled in the raw material tank 7. The solution was pressurized by the gas supplied from the compressed nitrogen gas cylinder 92 connected via the pressure controller and valve 82 and supplied at a rate of 10 ml/min to the nozzle 5 (AM 6, manufactured by Atomax Co., Ltd.) connected via the solution amount controlling equipment (liquid mass flow controller): LV-510, manufactured by HORIBA STEC Co., Ltd.) and valve 6. To the nozzle 5, a separate spray gas was supplied by a compressed nitrogen gas cylinder 91 connected via the pressure controller and valve 81 to carry out forming of droplets of the solution. The maximum linear velocity V₁ of the spray gas at the surface of the seed rod and the maximum linear velocity V₂ of the oxygen gas or hydrogen gas forming the oxyhydrogen flame, were 2.0 m/s and 2.8 m/s, respectively. The nozzle 5 and the oxyhydrogen flame burner 10 were disposed so that extensions of the respective center axes took an angle of 10°. The ratio d₂/d₁ of the maximum diameter d₂ of the seed rod to the inner diameter d₁ of the outermost layer of the multiple nozzle burner was d₂/d₁=4.4. To the oxyhydrogen flame burner 10 having multiple nozzles, a vapor of SiCl₄ was supplied from the center nozzle at a rate of 2.1 g/min, and from the outer layer nozzle, oxygen and hydrogen were supplied at rates of 4.81/min and 81/min, respectively.

To hydrolyze SiCl₄ as a raw material for the synthesis of synthetic quartz glass, SiCl₄, oxygen and hydrogen were supplied to the oxyhydrogen flame burner 10, and the droplets of the solution were sprayed from the nozzle 5 into the flame of the oxyhydrogen flame burner 10 to which SiCl₄, etc. were supplied, to obtain a porous quartz-type glass body containing lanthanum and aluminum.

This glass body was heated to 1,450° C. in an atmosphere of 100% helium gas and maintained at this temperature for 4 hours. Then, this glass body was heated to 1,700° C. in an atmosphere of 100% argon gas and maintained at this temperature for 4 hours to obtain transparent quartz-type glass. It contained lanthanum and aluminum in amounts of 1.6 mass % and 0.3 mass %, as calculated as La and Al, respectively.

Various evaluations were carried out in accordance with the following methods. The evaluation results in Examples 1 to 8 are summarized in Table 1. Here, Examples 1 to 3, 5 and 6 are working examples of the present invention, and Example 4 is a comparative example.

The refractive index at a wavelength of 193 nm can be estimated by the following method. By a precision refractometer (KPR-2, manufactured by Kalnew optical Industrial Co., Ltd.), refractive indices (n_{g}, n_{F}, nₑ, n_{d}, n_{D} and n_{c}) at g-line (wavelength of 436 nm, hereinafter λ_{g}), F-line (wavelength of 486 nm, hereinafter λ_{F}), e-line (wavelength of 546 nm, hereinafter λₑ), d-line (wavelength of 588 nm, hereinafter λ_{d}), D-line (wavelength of 589 nm, hereinafter λ_{D}) and C-line (wavelength of 656 nm, hereinafter λ_{A}) are measured.

Further, the refractive index (hereinafter n_{He-Ne}) at a wavelength of 633 nm (hereinafter λ_{He-Ne}) is measured by a Prism Coupler (PC2010, manufactured by Metricon Corporation). From the relation of n_{g}, n_{F}, nₑ, n_{d}, n_{D}, n_{He-Ne}, n_{c} and λ_{g}, λ_{F}, λₑ, λ_{d}, λ_{D}, λ_{C}, λ_{He-Ne}, in the Sellmeier's equation represented by the following formula (1), coefficients A, B, C and D are determined by a least squares method:
n²=A+(Bλ²/λ²−C)+Dλ² (1)

Using the determined coefficients, the refractive indices n_{KrF} and n_{ArF} at wavelengths of 248 nm (λ_{KrF}) and 193 nm (λ_{ArF}), respectively, are estimated.

The transmittance (hereinafter T, unit: %) at 193 nm is evaluated by means of a self-recording spectrophotometer (U-3500, manufactured by Hitachi, Ltd.). For the evaluation, a glass sample of 10 mm×20 mm×3 mm in thickness having both surfaces subjected to optical polishing, is used. In this specification, transmittance is defined to be one having the reflectance corrected on the basis that the transmittance at 2,000 nm is regarded to be 100%.

A metal element in quartz-type glass is quantified by a fluorescent X-ray analysis. Further, nitrogen is quantified by dissolving pulverized quartz-type glass in hydrofluoric acid and measuring the amount of ammonia gas thereby generated.

TABLE 1

| | n_{g} | n_{F} | nₑ | n_{d} | n_{D} | n_{He—Ne} | n_{C} | n_{KrF} | n_{ArF} | T |
|---|---|---|---|---|---|---|---|---|---|---|
| Ex. 1 | 1.470 | 1.466 | 1.462 | 1.460 | 1.460 | 1.459 | 1.458 | 1.522 | 1.577 | 44 |
| Ex. 2 | 1.471 | 1.466 | 1.463 | 1.461 | 1.461 | 1.460 | 1.459 | 1.527 | 1.588 | 39 |
| EX. 3 | 1.495 | 1.491 | 1.488 | 1.487 | 1.487 | 1.486 | 1.485 | 1.540 | 1.589 | |
| Ex. 4 | 1.467 | 1.463 | 1.460 | 1.458 | 1.458 | 1.457 | 1.456 | 1.511 | 1.559 | 90 |
| Ex. 5 | 1.476 | 1.472 | 1.468 | 1.466 | 1.466 | 1.465 | 1.464 | 1.528 | 1.583 | |
| Ex. 6 | 1.478 | 1.473 | 1.469 | 1.467 | 1.467 | 1.466 | 1.465 | 1.541 | 1.612 | |

In Examples 1 to 3, 5 and 6, the values of calculated n_{ArF} are larger than the value in Example 4. With quartz-type glass containing any one of lanthanum, aluminum, hafnium and nitrogen, high refractive indices can be obtained at 193 nm and 248 nm as compared with conventional quartz glass.

The entire disclosure of Japanese Patent Application No. 2005-095829 filed on Mar. 29, 2005 including specification, claims, drawings and summary is incorporated herein by reference in its entirety.

What is claimed is:

1. Quartz-type glass for a microlithographic projection exposure apparatus, which contains at least 51 mass % of SiO₂ and which further contains at least one member selected from the group consisting of lanthanum, aluminum, hafnium, nitrogen, scandium, yttrium and zirconium.

2. Quartz-type glass for a microlithographic projection exposure apparatus, which contains at least 51 mass % of SiO₂ and which further contains lanthanum and at least one member selected from the group consisting of hafnium and nitrogen.

3. Quartz-type glass for a microlithographic projection exposure apparatus, which contains at least 51 mass % of SiO₂ and which further contains at least two members selected from the group consisting of aluminum, hafnium and nitrogen.

4. Quartz-type glass for a microlithographic projection exposure apparatus, which contains at least 51 mass % of SiO₂ and which further contains hafnium and nitrogen.

5. The quartz-type glass for a microlithographic projection exposure apparatus according to claim 1, which is quartz-type glass containing lanthanum and aluminum, wherein lanthanum is contained in an amount of from 0.1 to 25 mass % as calculated as La, and aluminum is contained in an amount of from 0.1 to 15 mass % as calculated as Al.

6. The quartz-type glass for a microlithographic projection exposure apparatus according to claim 1, which is quartz-type glass containing hafnium, wherein hafnium is contained in an amount of from 1 to 25 mass % as calculated as Hf.

7. The quartz-type glass for a microlithographic projection exposure apparatus according to claim 1, wherein nitrogen is contained in an amount of from 0.1 to 10 mass %.

8. The quartz-type glass for a microlithographic projection exposure apparatus according to claim 1, which is used for microlithography with a light source having a wavelength of 193 nm.

9. The quartz-type glass for a microlithographic projection exposure apparatus according to claim 1, which is has a refractive index of more than 1.560 at a wavelength of 193 nm.

10. The quartz-type glass for a microlithographic projection exposure apparatus according to claim 1, which is used for microlithography by an immersion exposure method.

11. The quartz-type glass for a microlithographic projection exposure apparatus according to claim 1, which has a refractive index of more than 1.508 at a wavelength of 248 nm.

12. A process for producing quartz-type glass for a microlithographic projection exposure apparatus, which comprises impregnating a porous quartz-type glass body with a solution of at least one member selected from the group consisting of alkoxides of lanthanum, aluminum, hafnium, scandium, yttrium and zirconium by a solution impregnation method, followed by removal of a solvent and transparent vitrification.

13. A process for producing quartz-type glass for a microlithographic projection exposure apparatus, which comprises a step of subjecting a vapor of SiCl₄ to hydrolysis in a flame to form a porous quartz-type glass body, wherein a solution containing a metal chloride, a metal nitrate or a metal alkoxide of at least one metal element selected from the group consisting of lanthanum, aluminum, hafnium, scandium, yttrium and zirconium, in at least one of water and an organic solvent, is formed into droplets and sprayed into the flame to form a porous quartz-type glass body containing the above metal element, followed by transparent vitrification of the porous quartz-type glass body.
